(19) United States
(12) Patent Application Publication
(10) Pub. No.: US 2005/0246188 A1
(43) Pub. Date: Nov. 3, 2005

(54) Showroom having interactive displays and method therefor

(76) Inventor: Lorraine DeSimone, Scottsdale, AZ (US)

Correspondence Address: WEISS & MOY PC, 4204 NORTH BROWN AVENUE, SCOTTSDALE, AZ, 85251, US

(21) Appl. No.: 10/837,833

(22) Filed: May 3, 2004

(51) Int. Cl. G06F 17/60

(52) U.S. Cl. 705/1

(57) ABSTRACT

An interactive display office and method is used for showing virtual tours of property. The interactive display office and method has at least one interactive display device positioned in the interactive display office for showing virtual tours of property. The interactive display has a video display monitor. A video player is coupled to the video display monitor. An I/O device is coupled to the video player for controlling the video player.

### BACKGROUND OF THE INVENTION

1. Field of the Invention

This invention relates to a showroom and, more specifically, to a real estate office having one or more interactive video displays which show virtual tours, digital photos, floorplans, etc. of homes and/or office space which for sale/rent.

2. Description of the Prior Art

One of the biggest and most exciting thing a person may do is to purchase a home or start a new business. While exciting, looking for a house or office space to rent or buy may be a very burdensome and time consuming task. When looking for a home or office space, many people look at the newspaper or other printed publications to see what properties may be for sale or rent. The main problem with newspapers and printed publications is that these resources cannot show a person the details of the property. While newspapers and printed publications may have one or two photos of the property, one still cannot get a good visual image of the property without taking the time and effort to personally visit the property.

Recently, people have begun to use the internet as a means to find property to rent and/or purchase. The internet has numerous websites where one can rent and/or purchase different properties. Many of these websites have numerous pictures of different properties so that a person can get a better visual image of the property without taking the time and effort to personally visit the property. Some of the websites even have streaming videos of certain properties. However, many people still feel more comfortable having a real estate agent represent them when purchasing or renting property. Furthermore, the streaming videos shown on the websites are often of fairly poor quality and take some time to download and to view.

Because of the above problems, many people use a real estate agent to help them look for a home or office space which is for sale or rent. However, many people are unsure of what they want or can afford until they are able to see a few properties. These people would like to view different properties without having to enlist or feel obligated to a real estate agent. Even if they will ultimately choose to use a realtor, many people do not want to waste the real estate agent's time until they find certain properties they wish to personally see. Furthermore, there may be times where the real estate agent may be too busy to show a large number of different properties to a particular client.

Therefore, there is a need for an improved system and method for selling and renting property that over comes the problems associated with the prior art. The improved system and method will allow a person to view different properties without having to enlist a real estate agent, have access to a computer, or actually visit the site. This system will allow the public to freely and comfortably view the various properties without the assistance of a real estate agent. This will allow a person to narrow down the choices of properties he/she would like to physically visit. The improved system and method will additionally allow a real estate agent the opportunity to show a client different properties without having to physically visit the site. This will save the real estate agent time by only having to take the client to a few select properties.

### SUMMARY OF THE INVENTION

In accordance with one embodiment of the present invention, it is an object of the present invention to provide an improved system and method for selling and renting property that over comes the problems associated with the prior art.

It is another object of the present invention to provide an improved system and method that will allow a person to view different properties without having to actually visit the site.

It is another object of the present invention to provide an improved system and method that will allow a person to view different properties without having to actually visit the site, enlist a real estate agent, or even go into the sales office, thereby allowing a person to narrow down the choices of properties he/she would like to physically visit.

It is still another object of the present invention to provide an improved system and method will allow a real estate agent the opportunity to show a client different properties without having to physically visit the site.

It is yet another object of the present invention to provide an improved system and method will allow a real estate agent the opportunity to show a client different properties without having to physically visit the site thereby saving the real estate agent time by only having to take the client to a few select properties.

### BRIEF DESCRIPTION OF THE EMBODIMENTS

In accordance with one embodiment of the present invention an interactive display office for showing virtual tours of property is disclosed. The interactive display office has at least one interactive display device positioned in the interactive display office for showing virtual tours of property. The interactive display has a video display monitor. A video player is coupled to the video display monitor. An I/O device is coupled to the video player for controlling the video player.

In accordance with another embodiment of the present invention, a method for selling or renting property comprising: establishing a display office for showing virtual tours of the property; placing at least one interactive display device in the display office for allowing individuals to have interactive control of the virtual tours; and placing at least one non-interactive display device in the interactive display office for continuous showing of the virtual tours.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings.

FIG. 1 is an elevated perspective view of an office with the present invention.

FIG. 2 is a front view of one embodiment of the video display unit used in the present invention.

FIG. 3 is a back view of the video display unit depicted in FIG. 2.

FIG. 4 is an elevated perspective view of a person using the present invention.

### DETAILED DESCRIPTION OF THE PREFERRED EMBODIMENT

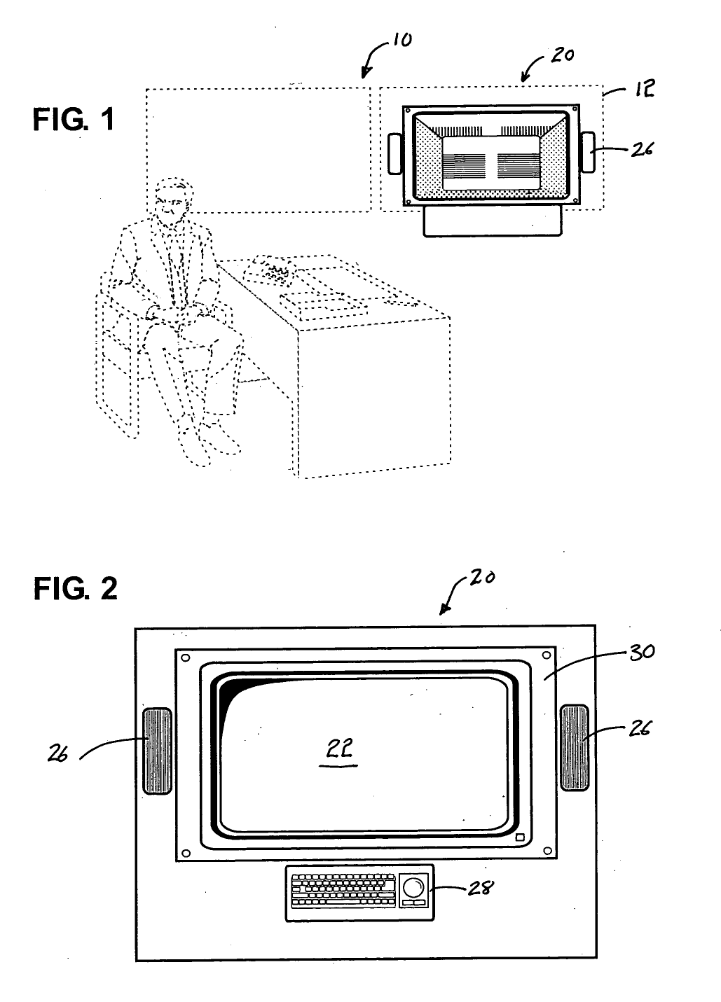

Referring to FIG. 1, an interactive display office 10 (hereinafter display office 10) is shown. The display office 10 is to be used by people to see virtual tours of different properties to be sold and/or rented. The display office 10 may be used by real estate agents to show properties to potential clients, travel agents to show different rental properties to clients, hotels and resorts to show certain amenities of the property, and the like. The display office 10 will also used by people to view properties prior to actually selecting a real estate agent. The listing of the above should not be seen as to limit the scope of the present invention.

The display office 10 will have one or more virtual displays 20. The virtual display 20 may be positioned anywhere in the display office 10. In accordance with one embodiment of the present invention, the virtual display 20 is positioned in a window 12 of the display office 10. Preferably, the window 12 is in the front of a building so individuals passing by the office can see the virtual display 20 positioned in the front window. This will allow people to select and view different properties without feeling obligated to talk with or enlist the real estate agent. Other virtual displays 20 can be positioned in other areas of the display office 10. For example, a virtual display 20 may be placed in a conference room, a waiting room/area, or the like. It should be noted that the above are given as an example and should not be seen as to limit the scope of the patent. The virtual display 20 may be an interactive virtual display or a non-interactive continuous running virtual display.

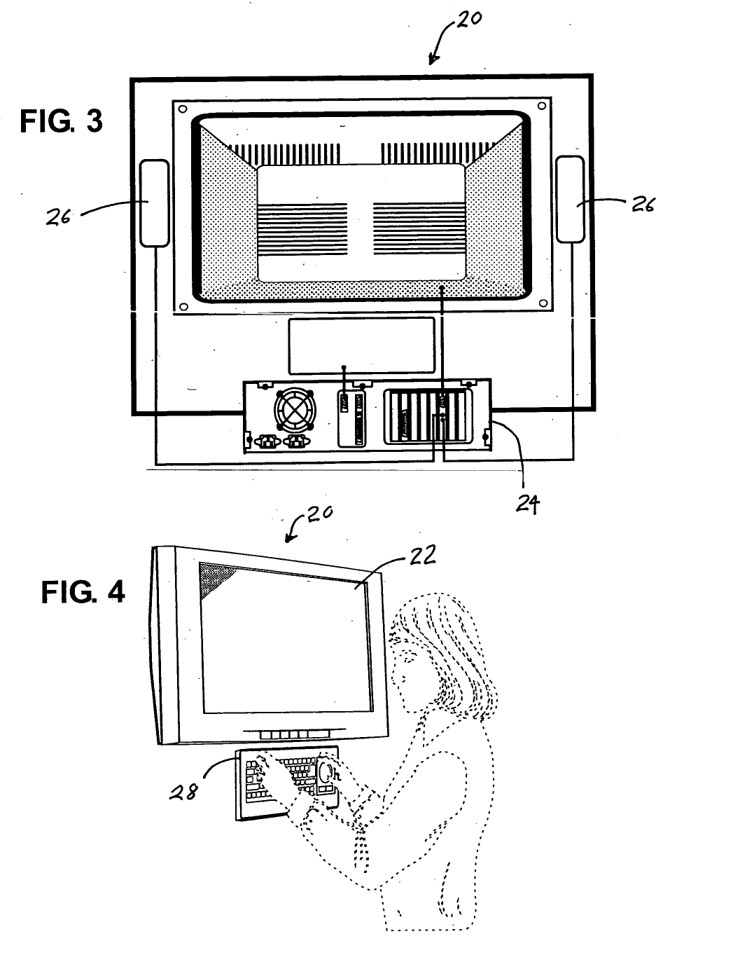

Referring to FIGS. 2-4, the virtual display 20 will have a display monitor 22. The display monitor 22 can be any type of monitor device. In accordance with one embodiment of the present invention, the display monitor 22 is a flat panel display. The flat panel display may be a plasma screen, a Liquid Crystal Display (LCD), a thin film electroluminescent display (TFEL), and the like. In general, a flat panel display 22 is used since flat panel displays 22 maybe mounted on a wall and tend to take up less space than a CRT monitor and the like.

The virtual display 20 will have a video player 24 coupled to the video display 22. The video player 24 will store recorded virtual tours of the properties to be displayed on the video display 22 and play the virtual tours when activated. The video player 24 may be a Video Cassette player/recorder (VCP/VCR), a Digital Video Disc (DVD) player/recorder, or a computer system having a hard drive or other memory storage device for storing the virtual tours. The type of video player 24 used depends on whether the virtual display 20 is an interactive virtual display or a non-interactive continuous running virtual display. If the virtual display 20 is interactive, then a computer system should probably be used.

The virtual display 20 will further have one or more speakers 26. The speaker 26 is generally coupled to the video player 24. The speaker 26 is used to provide audio signals from the video player 24. The audio signals may be spoken words, music or the like. The audio signals may be an audio description of the virtual tour, directions on how to use the virtual display 20, directions on how to get to the property being displayed, music to help one relax while viewing the virtual tour, and the like. The above are given as examples and should not be seen as to limit the scope of the present invention.

An I/O device 28 is coupled to the video player 24. The I/O device 28 is used to send command signals to the video player 24. The command signals are used to control operation of the video player 24. The I/O device 28 can be used to input search information so that the video player 24 will only show virtual tours of properties that fits the search criteria. The I/O device 28 can also be used to select certain properties to view. The I/O device 28 can further be used to allow an individual to control the movement of the virtual tour. One can even use the I/O device to enter contact information so that the real estate agent can contact the individual. The listing of the above is given as an example and should not be seen as to limit the scope of the present invention. The I/O device 28 may be a keyboard, a mouse, a touch pad, or the like.

In operation, one or more virtual displays 20 are positioned in the display office 10. Preferably, one virtual display 20 is positioned in the front window of the display office 10. The virtual display 20 is positioned behind a protective glass 30 so that the display monitor 22 can not be damaged by vandals or the like. The virtual display 20 in the front window will be a fully interactive virtual display. Thus, a computer or the like will be used as the video player 24. An I/O device 28 will also be coupled to the video player 24. The I/O device 28 will be positioned outside of the front window so that a person passing by may use the virtual display. This will allow people who are passing by the display office 10 to look at different properties on his/her own time. After a person has found some properties he/she would like to see, the person may contact a real estate agent in the display office 10.

Speakers 26 may also be coupled to the video player 24. The speakers 26 would be positioned outside of the front window so that the person outside using the virtual display 20 can hear the audible signals.

One or more other virtual displays 20 may be positioned in other areas of the display office 10. As stated above, a virtual display 20 may be placed in a conference room, a waiting room/area, or the like. The other virtual displays 20 positioned in the display office 10 may be interactive or non-interactive virtual display 20 based on the desire of the owner of the display office 10.

While the invention has been particularly shown and described with reference to preferred embodiments thereof, it will be understood by those skilled in the art that the foregoing and other changes in form and details may be made therein without departing from the spirit and scope of the invention.

1. An interactive display office for showing virtual tours of property comprising:
at least one interactive display device positioned in the interactive display office for showing virtual tours of property wherein the interactive display comprises:
a video display monitor;
a video player coupled to the video display monitor; and
an I/O device coupled to the video player for controlling the video player.

2. An interactive display office for showing virtual tours of property in accordance with claim 1 wherein the at least one interactive display device is positioned in a front window of the interactive display office and the I/O device is positioned outside of the interactive display office.

3. An interactive display office for showing virtual tours of property in accordance with claim 1 wherein the video display monitor is a flat panel video display.

4. An interactive display office for showing virtual tours of property in accordance with claim 1 wherein the video player is a computer system.

5. An interactive display office for showing virtual tours of property in accordance with claim 1 further comprising a plurality of interactive display devices.

6. An interactive display office for showing virtual tours of property in accordance with claim 5 wherein at least one of the plurality of interactive display devices is positioned in a front window of the interactive display office and the I/O device is positioned outside of the interactive display office and at least one of the plurality of interactive display devices positioned completely inside the interactive display office.

7. A display office for showing virtual tours of property comprising:
at least one interactive display device positioned in the display office for showing virtual tours of property wherein the interactive display comprises:
a first video display monitor;
a first video player coupled to the video display monitor; and
an I/O device coupled to the video player for controlling the video player;
at least one non-interactive display device positioned inside the display office wherein the interactive display comprises:
a second video display monitor; and
a second video player coupled to the video display monitor for continuous playing of the virtual tours.

8. An interactive display office for showing virtual tours of property in accordance with claim 7 wherein the at least one interactive display device is positioned in a front window of the office and the first I/O device is positioned outside of the interactive display office.

9. An interactive display office for showing virtual tours of property in accordance with claim 7 wherein the first and second video display monitors are flat panel video display.

10. An interactive display office for showing virtual tours of property in accordance with claim 7 wherein the first video player is a computer system.

11. A method of one of selling or renting a property comprising:
establishing a display office for showing virtual tours of the property;
placing at least one interactive display device in the display office for allowing individuals to have interactive control of the virtual tours; and
placing at least one non-interactive display device in the interactive display office for continuous showing of the virtual tours.

12. The method of claim 11 wherein placing the at least one interactive display further comprises:
providing a video display monitor;
providing a video player coupled to the video display monitor; and
providing an I/O device coupled to the video player for controlling the video player.

13. The method of claim 12 further comprising:
positioning the video display in a front window of the interactive display office; and
positioning the I/O device outside of the interactive display office.

14. The method of claim 13 wherein the video display monitor is a flat panel video display.

15. The method of claim 13 wherein the video player is a computer system.
